(19) United States
(12) Patent Application Publication
(10) Pub. No.: US 2024/0115981 A1
(43) Pub. Date: Apr. 11, 2024

(54) Biodegradable cellulose-based filter media and facial masks including the same

(71) Applicant: Ahlstrom Oyj, Helsinki (FI)

(72) Inventors: Robin Abderrahmen, Bourgoin Jallieu (FR); Patrice Blanc, Saint-Genis-Laval (FR); Noël Cartier, Jardin (FR); Audrey Martignat, Vénissieux (FR); Hervé Papa, Pont-Evêque (FR)

(21) Appl. No.: 18/275,421

(22) PCT Filed: Feb. 2, 2022
(86) PCT No.: PCT/FI2022/050067

§ 371 Date: Aug. 2, 2023

Related U.S. Application Data
(60) Provisional application No. 63/144,627, filed on Feb. 2, 2021.

(51) Int. Cl. B01D 39/18; A41D 13/11; B01D 39/16

(52) U.S. Cl. CPC B01D 39/18; A41D 13/11; B01D 39/1623; B01D 2239/0266; B01D 2239/0618; B01D 2239/0636; B01D 2239/064; B01D 2239/065; B01D 2239/0654; B01D 2239/10; B01D 2239/1225; B01D 2239/1258; B01D 2239/1291

(57) ABSTRACT

A cellulose-based filter media (10) is disclosed having a first phase (14) and a second phase (16), wherein the first phase (14) includes refined cellulose fibers, and wherein the second phase (16) includes cellulose fibers along with at least one of cellulose-based man-made fibers or non-cellulose man-made fibers. A facial mask (18) having the filter media (10) and a process for making the filter media (10) are also disclosed. Due to the composition of the filter media (10), the filter media (10) and/or facial mask (18) incorporating the same are at least partially biodegradable, compostable, and/or recyclable and can be formed from a wet laid process.

### FIELD

The invention relates to at least partially biodegradable cellulose-based filter media, and to biodegradable facial masks including the filter media suitable for protecting a user against airborne pathogens and particulates.

### BACKGROUND

As is known, in the current pandemic environment, disposable facial (respiratory) masks, e.g., surgical, medical, or civil facial masks, are increasingly being required in public and private locations globally. Typically, the disposable facial masks include multiple layers. A first layer is intended to be in contact with the skin and includes a smooth material surface for comfort of the user. Thereafter, an intermediate filter layer is provided which contains a material configured to prevent inhalation of particulates, pathogens, or the like. Thereafter, an outer protective layer is provided which is intended to protect the filter media from exposure to significant moisture, dirt, and other larger particulates.

Currently, the above-described intermediate filter layers are made by melt-blown process technology. However, melt-blown processes are low speed and have limited production capacity worldwide, which is a problem for the current and extensive global need for disposable facial masks. Furthermore, melt-blown filtration layers are currently formed from polypropylene or synthetic polymers. These materials are fossil fuel-based, which is not preferred when compared to renewable resources. Also, such materials have limited end-of-life options, as they are not biodegradable, compostable, or recyclable. The significant daily usage globally of non-biodegradable facial masks, since the beginning of the pandemic and for the foreseeable future, has created and continues to create long-term landfill and disposal issues.

Attempts have been made to utilize use paper-based materials instead of melt-blown materials for use in manufacturing facial masks. However, proposed solutions have failed for either a lack of breathability, lack of bacterial filtration efficiency (BFE), lack of particulate filtration efficiency (PFE), or a lack of mechanical strength. It is very challenging to obtain a paper-based filter media which meets all the necessary requirements, e.g., thickness, basis weight, breathability, BFE, or PFE. By way of example, paper materials that have suitable breathability typically have an unsuitable BFE. Likewise, paper materials that have a suitable BFE typically have unsuitable breathability.

Accordingly, there is a need for a filter media suitable for use in facial masks, which is fully effective against particulates and pathogens, has an appropriate thickness and basis weight for use in a mask, is easily manufacturable, and which is also at least partially biodegradable, compostable, and/or recyclable to assist with the tremendous current need global need for facial masks and the need to reduce resulting landfill volume and disposal issues.

In order to solve, at least partly, the problems listed here-above, the applicant has developed a biodegradable cellulose-based filter media and biodegradable facial masks including the same.

### SUMMARY

In one aspect of the invention, there is provided a cellulose-based filter media comprising at least 50 wt % refined cellulose fibers. In another aspect, there is provided a facial mask comprising the cellulose-based filter media comprising at least 50 wt % refined cellulose fibers.

In another aspect of the invention, there is provided a biodegradable facial mask comprising a cellulose-based filter media, wherein the cellulose-based filter media comprises a first phase and a second phase, wherein the first phase comprises refined cellulose fibers, and wherein the second phase comprises cellulose fibers along with at least one of cellulose-based man-made fibers or non-cellulose man-made fibers.

In another aspect of the invention, there is provided a cellulose-based filter media comprising a first phase and a second phase, wherein the first phase comprises refined cellulose fibers, and wherein the second phase comprises cellulose fibers along with at least one of cellulose-based man-made fibers or non-cellulose man-made fibers.

In another aspect of the invention, there is provided a process for manufacturing a cellulose-based filter media comprising:
wet laying and draining at least two furnishes of cellulose fibers onto a screen assembly to form a web, wherein the at least two furnishes provide a first phase and a second phase in the web, wherein the first phase comprises refined cellulose fibers, and wherein the second phase comprises cellulose fibers along with at least one of cellulose-based man-made fibers or non-cellulose man-made fibers; and
drying the web to form the cellulose-based filter media.

Several advantages are realized in the above-referenced cellulose-based filter media and facial masks incorporating the filter media. Due to the high cellulose content of the filter media (e.g., 50 wt % or more), the filter media and/or facial mask incorporating the same are at least partially biodegradable, compostable, and/or recyclable.

In an embodiment, the filter media and facial masks incorporating the same are at least 50% biodegradable, preferably at least 60%, at least 75%, at least 95%, or at least 99% biodegradable according to EN 13432.

In addition, when used as the filter media in a facial mask, the filter media provides a desirable combination of performance between particle filtration efficiency (PFE) and/or Bacterial Filtration efficiency (BFE) and breathability. In one aspect, the filter media described herein provides for excellent BFE or PFE values in wet-laid facial masks without also surrendering desirable breathability and air permeability. Furthermore, the filter media can have a thin profile and be lightweight, which further adds to its desirability within a facial mask product.

Still further, due to its high cellulose content, the filter media can be easily manufactured via a wet laid process, which enables high output and global manufacture of facial mask products that are in extremely high demand globally. The manufacture of the filter media by a wet-laid process also eliminates the need for adhesives and binders in the filter media, thereby further reducing costs, and increasing the ease and speed of manufacture.

A filter media and/or facial masks incorporating the filter media may further present one or more of the following technical features taken alone or in combination.

As mentioned above, the attempts at production of a cellulose-based filter media for use in facial masks and facial masks incorporating the same have failed to date, as it is very challenging to arrive at a media that reaches all the desired criteria. In one aspect, the present inventors have surprisingly found that a combination of breathability, and BFE and/or PFE can be obtained via the use of refined cellulose fibers, optionally along with other fiber types in the formation of the filter media as described herein. By controlling the amount and degree of refining, for example, filter media and filter masks can be produced which have a balance of all the desired properties.

### BRIEF DESCRIPTION OF THE DRAWINGS

FIG. 1 illustrates a filter media in accordance with an aspect of the present invention.

FIG. 2 illustrates a filter media comprising a first phase and a second phase in accordance with another aspect of the present invention.

FIG. 3 illustrates a multi-layer mask in accordance with another aspect of the present invention.

FIG. 4 illustrates a facial mask incorporating a filter media as described herein in accordance with another aspect of the present invention.

FIGS. 5 and 6 illustrates a Scanning Electron Microscope images showing a first phase and a second phase of a filter media, respectively, in accordance with another aspect of the present invention.

### DETAILED DESCRIPTION

A filter media and/or facial masks incorporating the filter media may further present one or more of the following technical features taken alone or in combination.

As used herein, the terms “refined” or “refining” refer generally to a mechanical treatment of paper pulp fibers for papermaking. In certain embodiments, the filter media and masks incorporating the same utilize refined cellulose fibers to obtain a balance between breathability and BFE and/or PFE, as well as provide a filter media with a desirable thickness and basis weight.

As used herein, the term “refined cellulose” refers to natural, non-modified cellulose that has been subjected to a refining process.

As used herein, by “filtration efficiency” as used herein, it is meant either or both of bacterial filtration efficiency (BFE) or particle filtration efficiency (PFE).

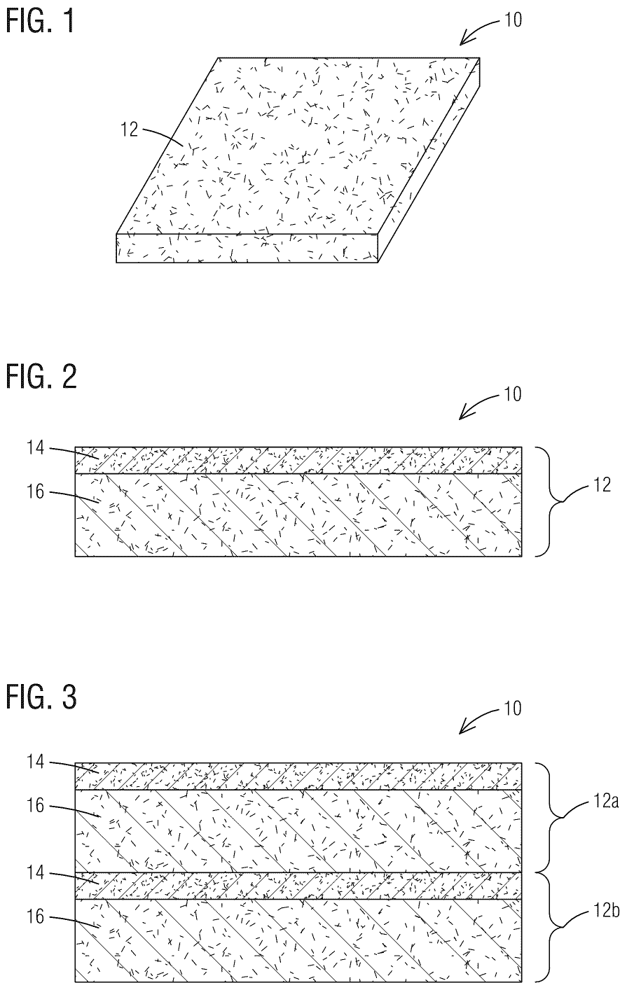

Referring now to FIG. 1, there is shown a filter media 10 in accordance with an aspect of the present invention comprising at least one layer 12 of refined cellulose fibers. The filter media 10 comprises at least 50 wt %, preferably at least 60 wt %, or more preferably at least 65 wt % of refined cellulose fibers. The high cellulose content allows for at least partial, if not complete, biodegradability, compostability, and/or recyclability of the filter media 10 and facial masks incorporating the filter media 10. In addition, as mentioned above, the high cellulose content also allows the filter media 10 to be manufactured by a wet-laid process, thereby enabling rapid and large volume manufacture of the filter media and masks including the same globally to meet high demand.

In an embodiment, the filter media 10 is at least 50% biodegradable, preferably at least 60%, at least 75%, at least 95%, or at least 99% biodegradable according to EN 13432. In certain embodiments, the filter media 10 is further at least partially compostable according to ASTM D6400 or ASTM D6868 standards. In further embodiments, the filter media 10 is at least partially recyclable.

In an embodiment, the filter media 10 has a particle filtration efficiency (PFE) of at least 70% at 3 μm, preferably at least 95%, measured with 3 μm Di-Ethyl-Hexyl-Sebacat (DEHS) particles using a PALAS bench MFP 3000 (flow rate=8 cm/s; surface testing approximately =100 cm²).

In an embodiment, the filter media 10 has a bacterial filtration efficiency (BFE) greater than 50%, preferably at least 95% according to the EN 14683: 2019, Annex B standard or the ASTM F2101-19 standard. In an embodiment, the BFE test is performed using an aerosolized suspension of Staphylococcus aureus at 3 μm; BFE testing area is approx. 40 cm²; and BFE flow rate: 28.3 L/min.

In an embodiment, the filter media 10 has an air permeability of filtration layer of from 200 to 800 L/m²/s. The air permeability determination was performed on a FX 3300 TEXTEST, adapted from standard DIN 53.887. The test pressure was 196 Pa and the surface of measurement was approximately 20 cm².

In an embodiment, the filter media 10 has a micro-bacterial cleanliness of ≤30 cfu/g when the filter media is configured for use in a medical mask according to the EN 14683 standard or the ISO 11737-1 standard.

In an embodiment, the filter media 10 has a differential pressure less than 60 Pa/cm², and preferably less than 40 Pa/cm² according to the EN 14683:2019, Annex C standard or the ASTM F2100-19 standard. In an embodiment, the differential pressure is measured using a manometer at a constant flow rate of 8 L/min with surface area of approximately 40 cm².

In an embodiment, the filter media 10 comprises a total thickness of 40 to 200 μm. In this way, the filter media 10 is lightweight and has a sufficiently thin profile to be utilized as the filter media layer in a facial mask as is described in further detail below. In certain embodiments, the filter media 10 may comprise one or more of the layers 12 of material comprising at least 50% refined cellulose fibers as described herein. In addition, in the case of a plurality of layers 12, each layer 12 may be identical or may vary in composition.

In an embodiment, at least a portion of the cellulose fibers in the filter media 10 are refined cellulosic fibers. In an embodiment, the refined cellulose fibers are refined to a level from 20° SR to 85° SR, such as from 40° SR to 60° SR, to provide a desirable equilibrium between breathability and particle/bacterial filtration efficiency of the filter media 10. In a particular embodiment, the refined cellulose fibers are refined to a level of from 45° SR to 60° SR.

The present inventors have found that, in certain embodiments, a refining level of from 20° SR to 85° SR is particularly suitable for the filter media 10 described herein. ° SR measures the freeness of a fibers suspension. A greater number equates to slower draining. In an embodiment, the ° SR values referred to herein may be measured by following a method adapted from ISO 5267-1:1999. The method may be performed on a Noviprofibre device called “appareil de degree Schopper” (device for measuring Schopper degree), using a pulp concentration of 2 g/L (2 grams of pulp in one 1 liter of water for each measure).

Further, when the cellulose fibers comprise refined cellulose fibers, it is understood that the refining of the fibers generally breaks and fibrillates the fibers, which increases their surface area. This process reduces air permeability of the refined fibers, but increases the particle filtration efficiency. Refining can improve also the physical cohesion within and between the phases. Due to this improved physical cohesion, there is a lesser need or no need at all to use fiber binders or other additives to improve mechanical properties.

Further, it is understood that refining tends to increase the content of fines and macrofibrills. In certain embodiment, refined cellulose fibers may comprise at least 30% in length of fines, preferably at least 34% in length of fines. In certain embodiments, refined cellulose fibers may also comprise at least 0.35% in length of macrofibrills. As used herein, the term “fines” refers to cellulosic components whose length is less than 0.2 mm. In addition, as used herein, the term “macrofibrills” refers to bundled elementary cellulose microfibrills forming a larger fibril. These fibrils may be oriented in a different direction with respect to the axis of the fiber.

The content of fines and macrofibrills may be measured using, for example, a Morfi® Analyzer LAB LB03. A fines rate (% in length) may be measured by summing up all the length of all the fines and dividing by the total length of detected objects. A macrofibrills rate may be measured by summing up the number of macrofibrills and dividing by the total length of detected fibers.

In an embodiment, the filter media 10 further comprises a wet strength agent. The wet strength agent may be useful for providing mechanical strength to the filter media 10 when exposed to moisture, such as moisture from the mouth of a user when the filter media 10 is incorporated into a mask product and worn by the user.

Referring now to FIG. 2, in an embodiment, the filter media 10 comprises a first phase 14 and a second phase 16. The present inventors have found that the two phase system aids in providing a balance between breathability and BFE and/or PFE. In such embodiments, the first phase 14 may provide a greater degree of filtration efficiency to the filter media 10 while the other (second) phase 16 may provide a greater degree of breathability than the first phase 14. Collectively, however, they create a gradient of filtration efficiency (not possible within a conventional filter media or layer) and provide the filter media 10 with a balance of the desired qualities and masks including the same.

To achieve this delicate balance of desired properties, in one embodiment, the first phase 14 comprises refined cellulose fibers and the second phase 16 comprises cellulose fibers along with at least one of cellulose-based man-made fibers or non-cellulose man-made fibers. In one embodiment, the cellulose fibers of the second phase 16 comprise refined cellulose fibers.

In certain embodiments, the first phase 14 comprises at least 25 wt %, at least 50% wt %, at least 60 wt %, at least 75 wt %, at least 80 wt %, or at least 90 wt % of refined cellulose fibers. In particular embodiments, the first phase 14 comprises 100 wt % refined cellulose fibers.

The phases 14, 16 each have a thickness and a total basis weight suitable to provide a lightweight, mechanically strong filter media with the desirable filtration efficiency and breathability profiles described herein.

In an embodiment, the first phase 14 has a thickness of 5 to 70 μm and the second phase 16 has a thickness of 35 to 150 μm.

In an embodiment, the first phase 14 comprises a basis weight of 4 to 15 gsm and the second phase 16 comprises a basis weight of 10 to 40 gsm.

The present inventors noted several observations in the development of the filter media 10 and masks as described herein.

In an embodiment, at least a portion of the refined cellulose fibers of the first phase 14 are derived from hardwood pulp. Hardwood pulp may be particularly suitable to improve filtration efficiency within the first phase 14, but tends to decrease air permeability. The present inventors have found that a particularly useful hardwood pulps for the first phase 14 to provide excellent filtration efficiency are Pontevedra, Celtejo TF CF or Cenibra EC pulps, although it is understood the invention is not so limited and that other hardwood or other types of cellulose-based fibers may be selected for the first phase 14.

In a particular embodiment, the first phase 14 comprise fibers derived from Pontevedra. The cellulose fibers of Pontevedra tend to be finer and thus less permeable to air. As with other hardwood fibers, these fibers can help improve the particle filtration efficiency, but also tend to decrease the air permeability. Refining can further improve this efficiency. However, too much refining would likely substantially reduce the air permeability to undesirable degree.

In an embodiment, the cellulose fibers from hardwood are refined cellulose fibers. In an embodiment, the refined cellulose fibers of hardwood may comprise at least 30% in length of fines, and preferably at least 32% in length of fines. The refined cellulose fibers of hardwood may comprise also comprise at least 0.4% in length of macrofibrills.

As discussed above, the second phase 16 may be constructed to provide more of a degree of breathability to the filter media 10. To accomplish this, in an embodiment, the second phase 16 also includes an amount of cellulose fibers along with either or both of cellulose-based man-made fibers and non-cellulose man-made fibers. In an embodiment, the cellulose fibers of the second phase 14 comprise refined cellulose fibers. FIGS. 5 and 6 depict Scanning Electron Microscope images showing the first phase 14 and the second phase 16 of a filter media 10, respectively. As can be seen, the first phase 14 presents a rather tortuous path compared to the second phase 16 and is less breathable relative to the second phase 16.

It is further understood that greater levels of refining lead to the reduction of air permeability. To counterbalance this effect, the inventors also attempted to reduce the basis weight of the first layer. If a lower basis weight is desired, the amount refining can be increased. Also, if a greater basis weight is desired, the refining may be decreased in order to have similar levels of particle filtration efficiency to a layer having a lower basis weight and greater levels of refining.

In certain embodiments, the second phase 16 may comprise man-made cellulose-based fibers, such as Lyocell or Rayon (1.7 dtex—4 to 8 mm). These man-made, cellulose-based fibers are larger fibers compared to natural fibers, and may be added in the second phase 16 to improve the breathability of the filter media.

In particular embodiments, the man-made, cellulose-based fibers comprise fibrillated fibers (e.g., fibrillated Lyocell) may also be considered to be refined man-made cellulose-based fibers in the context of the present invention. These fibrillated, man-made, cellulose-based fibers may assist in providing the required particle filtration efficiency, but tend to decrease permeability to air. Without wishing to be bound by theory, it is believed that these fibers tend to have longer fibrils that cause the above effects.

Further, it is appreciated that the cost of man-made cellulosic fibers is greater than the natural cellulose fibers. It was found that the contribution of refined cellulose-based man-made fibers (such as fibrillated Lyocell) to particle filtration efficiency was marginal relative to the decrease in air permeability. Given this and their high cost, their inclusion into the first phase 14 may be limited or excluded. However, unrefined and refined man-made cellulosic fibers are suitable for use in the second phase 16, which has higher air permeability relative to the first phase 14.

In particular embodiments, the second phase 16 comprises refined cellulose fibers, and the refined cellulose fibers of the second phase 16 comprise softwood fibers, hardwood fibers as described above, or annual plant fibers, such as Abaca fibers.

In an embodiment, the filter media 10 comprises cellulose fibers derived from annual plants, such as from Abaca. Abaca pulp typically comprises very strong cellulose fibers. This pulp may thus be used to provide the required mechanical properties for the filter media 10, when needed. In an embodiment, when the filter media 10 comprises a first phase 14 and a second phase 16, the second phase 16 comprises cellulose fibers from annual plants.

In an embodiment, the cellulose fibers from annual plants are refined cellulose fibers from annual plants. In an embodiment, the refined cellulose fibers of annual plants may comprise at least 30% in length of fines, and preferably at least 32% in length of fines. The refined cellulose fibers of annual plants may comprise also comprise at least 0.4% in length of macrofibrills.

In an embodiment, the filter media 10 comprises cellulose fibers derived from softwood trees, such as from Sodra pulp. The softwood cellulose fibers tend to be larger than the cellulose fibers of hardwood. It may be included in the first (base) phase to improve the mechanical properties of the of the filter media. In an embodiment, when the filter media comprises a first phase 14 and a second phase 16, the second phase 16 comprises cellulose fibers from softwood trees.

In an embodiment, the cellulose fibers from softwood trees are refined cellulose fibers from softwood trees. In an embodiment, the refined cellulose fibers of softwood may comprise at least 30% preferably at least 33% in length of fines. The refined cellulose fibers of softwood may comprise also comprise at least 1% in length of macrofibrills.

Further, in an embodiment, cellulose-based man-made fibers are present in the second phase 16 and are selected from the group consisting of Lyocell, fibrillated Lyocell, and viscose fibers, such as Rayon. Lyocell and Rayon fibers tend to further provide enhanced breathability of the material for the filter media 10 due to their relatively thicker and longer size. Fibrillated Lyocell further tends to contribute to the filtration efficiency.

In an embodiment, the cellulose-based man-made fibers are present in the second phase 16 and comprise a fineness of 0.5 to 5 dtex and a length of 1 to 20 mm, preferably 3 to 8 mm.

Further, in the second phase 16, non-cellulose man-made fibers may also be provided which provide an excellent equilibrium between breathability and filtration efficiency. Typically, the lower the diameter of the non-cellulose man-made fibers, the greater the filtration efficiency.

When present, the non-cellulose man-made fibers of the second phase 16 may be selected from the group consisting of polyesters, co-polyesters, bicomponent polyester/polyolefin, modified polyesters, polyolefin, polyaramids, polyamides or biopolymers, such as polylactic acids, polybutylene succinates, polybutylene succinate co-adipates, polycaprolactones, polybutyrate adipate terephthalates, and combinations thereof.

In an embodiment, the non-cellulose man-made fibers have a fineness of 0.02 to 1 dtex and a length of 0.5-15 mm, preferably 1-10 mm.

In a particular embodiment, the second phase 16 comprises the following composition:
from 30 to 90 wt % of refined cellulose fibers;
from 0 to 40 wt % unrefined cellulose-based man-made fibers;
from 0 to 25 wt % of cellulose-based man-made fibers; and
from 0 to 50 wt % of non-cellulose man-made fibers.

In a further particular embodiment, the second phase 16 comprises the following composition:
from 15 to 45 wt % of first refined cellulose fibers refined to a level from 20° SR to 55° SR;
from 15 to 45 wt % of second refined cellulose fibers different from the first refined cellulose fiber refined to a level from 20° SR to 55° SR;
from 0 to 40 wt % unrefined cellulose-based man-made fibers;
from 0 to 25 wt % of cellulose-based man-made fibers refined to a level of from 50° SR to 85° SR;
from 0 to 20 wt % cellulose fibers highly-refined to a level of from 45° SR to 85° SR; and
from 0 to 50 wt % of non-cellulose man-made fibers.

In a further particular embodiment, the second phase 16 comprises the following composition:
from 15 to 45 wt % of first refined cellulose fibers refined to a level from 20° SR to 55° SR;
from 15 to 45 wt % of second refined cellulose fibers different from the first refined cellulose fiber refined to a level from 20° SR to 55° SR;
from 1 to 40 wt % unrefined cellulose-based man-made fibers;
from 1 to 25 wt % of cellulose-based man-made fibers refined to a level of from 50° SR to 85° SR;
from 1 to 20 wt % cellulose fibers highly-refined to a level of from 45° SR to 85° SR; and
from 1 to 50 wt % of non-cellulose man-made fibers.

In an embodiment, the first phase 14 is thinner than the second phase 16 in the formed filter media 10.

The filter media 10 may comprise one or more layers 12 as shown in the Figures. In an embodiment, the filter media 10 comprises a single layer 12 as shown in FIGS. 1-2. In such embodiments with a single layer, the filter media 10 has a total basis weight of 15 to 65 gsm, preferably 25 to 35 gsm.

In an embodiment, as shown in FIG. 3, the filter media 10 comprises at least two layers 12a, 12b, each of which may have a composition as described herein. In the embodiment shown in FIG. 3, each layer 12a, 12b may comprise a first phase 14 and a second phase 16; however, the present invention is not so limited. In an embodiment, the filter media 10 having the at least two layers 12a, 12b comprises a total basis weight of 30 to 130 gsm, preferably 40 to 70 gsm.

As noted above, the cellulose fibers of the filter media 10 may be refined to provide the desired characteristics in the filter media 10. In an embodiment, the refined cellulosic fibers of the first phase 14 and the second phase 16 are refined to a level from 20° SR to 85° SR to provide a desirable equilibrium between breathability and particle/bacterial filtration efficiency of the filter media 10. In a particular embodiment, the refined cellulose fibers of the first phase 14 are refined to a level from 45° SR to 60° SR to provide a desired filtration efficiency to the first phase 14 while providing for some breathability.

The filter media 10 disclosed herein can be incorporated into a mask as insert and/or manufactured with one or more additional layers to provide a wearable respiratory mask, e.g., a surgical, medical, or civil mask as are known in the art. Such masks are typically also manufactured with elastic members for securement around the user's ears, and may comprise any other structural feature to help provide a snug fit of the mask over a user's face.

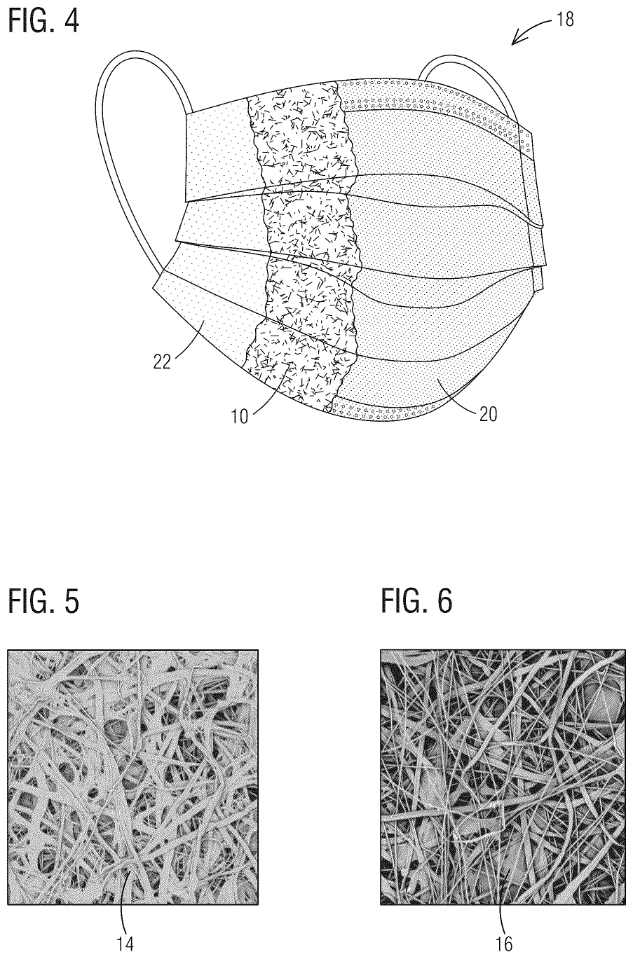

In certain embodiments and as shown in FIG. 4, a facial mask 18 is disclosed comprising the filter media 10 sandwiched between a first (inner) layer 20 configured for contact with the face of a user and a second layer 22 different from the first layer 20. The second (outer) layer 22 is intended to be the outermost layer of the mask 18 and directly in contact with the outside environment when the mask 18 is worn by the user.

The inner layer 20 may comprise any suitable material suitable for an inner layer of a facial mask known in the art or otherwise described herein. In an embodiment, the inner layer 20 comprises a wet laid fibrous layer, preferably having a suitable degree of breathability. In other embodiments, the inner layer 20 may comprise a spunbond layer.

The second (outer) layer 22 may comprise any suitable material suitable for an outer layer of a facial mask known in the art or otherwise described herein. In an embodiment, the outer layer 22 may also comprise a spunbond layer. In an embodiment, the inner and/or outer (first or second) spunbond layers may comprise a member selected from the group consisting of polypropylene, polyethylene, one or more biopolymers, and combinations thereof. The biopolymers may be selected from polylactic acids, polybutylene succinates, polybutylene succinate co-adipates, polycaprolactones, or polybutyrate adipate terephthalates.

In another embodiment, the inner and/or outer (first or second) layers 20, 22 may comprise wet-laid layers comprising cellulose fibers and/or cellulose based man-made fibers together with fibers of a material selected from the group consisting of polypropylene, polyethylene, polylactic acids, polybutylene succinates, polybutylene succinate co-adipates, polycaprolactones, or polybutyrate adipate terephthalates and combinations thereof. In certain embodiments, the first or second wet-laid layer may be subjected to chemical treatment with a binder such as an aqueous, anionic dispersion of a copolymer of n-butylacrylate, acrylonitrile and styrene, and with other additives such as polyethylene glycol.

In certain embodiments, the masks 18 are surgical, medical, or civil masks, and are graded for such uses as the case may be.

In certain embodiments, the filter media 10 is interchangeable within a body of the facial mask 18. In this way, the body of the mask 18 (portion of the mask 18 without the filter media 10) may be reused, and in some instances, may even be washable while the filter media 10 is changed out as needed for optimal function of the filter media 10.

In certain embodiments, due to the construction of the mask 18 and/or the filter media 10, the facial mask 18 is at least 50% biodegradable, at least 60% biodegradable, at least 75% biodegradable, at least 95% biodegradable, or at least 99% biodegradable according to EN 13432. In certain embodiments, the mask 18 comprising the filter media 10 described herein are also at least partially compostable according to EN13432 (September 2000), ASTM D6400, or ASTM D6868 standards. In further embodiments, the masks 18 comprising the filter media 10 described herein are also at least partially recyclable.

The filter media 10 and masks 18 as described herein may be formed by any suitable process. In an embodiment, the filter media 10 may be formed by a wet-laid process. In an embodiment, the fibers of the first phase 14 and the second phase 16 are formed by a wet-laid process to enable integration of the first and second phases 14, 16. Forming the filter media 10 via a wet laid process enables cost-effective, efficient, rapid, and global manufacture of the product without the use of binders, adhesives, and the like.

In a particular embodiment, the filter media 10 can be produced via a wet-laid process in a paper machine. In this embodiment, two furnishes are prepared with the desired fiber composition. A first furnish is used for the first phase 14 and a second furnish is used for the second phase 16. The paper machine is equipped with a headbox with two compartments, wherein each compartment is fed with respectively with the first and second furnish. The first phase 14 and the second phase 16 are formed simultaneously on a continuously moving forming wire of a paper machine.

By utilizing a wet laid process, the first phase 14 is formed onto the second phase 16. As such, the first phase 14 may also be referred to as a “top” phase herein and the second phase may also be referred as a “base” phase herein. The assembly, which is very wet at this stage, is further dewatered, for example, with one or more dewatering boxes, and/or by pressing. The assembly is then dried to obtain the desired filter media. The drying can be utilizing any suitable structure or process, such as via air dryer cylinders (TAD) and/or oven drying.

In another aspect, there is disclosed a process for manufacturing a cellulose-based filter media comprising:
wet laying and draining a furnish of cellulose fibers onto a screen assembly to form a web; and
drying the web to form the cellulose-based filter media.

In certain embodiments, at least 50 wt %, at least 60 wt %, at least 75 wt %, at least 80 wt %, or at least 90 wt % of the cellulose fibers comprise refined cellulose fibers.

In an embodiment, at least two furnishes are provided during the wet laying to provide the first phase 14 and second phase 16 described herein. Thus, in an embodiment, a first furnish may be provided which comprises a fiber composition suitable for producing any embodiment of the first phase 14 as described herein. In addition, in an embodiment, a second furnish may be provided which comprises a fiber composition suitable for producing any embodiment of the second phase 16 as described herein.

As was also noted above, the cellulose fibers of the filter media 10 may be refined to provide the desired characteristics in the filter media, e.g., a desired breathability and/or filtration efficiency. In an embodiment, the refined cellulosic fibers of the first furnish and/or second furnish are refined to a level from 20° SR and 85° SR to provide a desirable equilibrium between breathability and particle/bacterial filtration efficiency of the filter media 10. In a particular embodiment, the refined cellulose fibers of the first furnish are refined to a level from 45° SR to 60° SR to provide the desired filtration efficiency to the first phase while providing for some breathability.

### EXAMPLES

Examples 1.1-1.6 and 2.1-2.3 were manufactured according to the following compositions. The resulting properties thereof were measured and recorded as follows in Tables 1-2.

TABLE 1

| | | | | | | |
|---|---|---|---|---|---|---|
| Fibers used | Ex. 1.1 | Ex. 1.2 | Ex. 1.3 | Ex. 1.4 | Ex. 1.5 | Ex. 1.6 |

Top phase

| | | | | | | |
|---|---|---|---|---|---|---|
| Mitsui PE pulp E-790 | 75% | | | | | |
| Pontevedra (45-55° SR) | | 100% | 100% | 100% | 100% | 100% |
| Sodra Blue Z (0 to 40° SR) | 25% | | | | | |
| Top phase basis weight (gsm) | 8 | 9 | 9 | 8 | 8 | 7 |

Base phase

| | | | | | | |
|---|---|---|---|---|---|---|
| Abaca 410 (35-40° SR) | 25% | 30% | 35% | 30% | 30% | 35% |
| Teijin TA04PN 3 mm/0.1 dtex | | 20% | | | 30% | |
| Fibrillated Lyocell(60-70° SR) | 25% | | | 15% | | |
| Rayon 8 mm/1.7 dtex | | | | 25% | 10% | |
| Lyocell 6 mm/1.7 dtex | | 20% | 20% | | | 30% |
| Rayon 5 mm/1.7 dtex | 25% | | | | | |
| Pontevedra (35-40° SR) | 25% | 30% | 35% | 30% | 30% | 35% |
| Floc (sodra & Pontevedra) | | | 10% | | | |
| (75-85° SR) | | | | | | |
| Base phase basis weight (gsm) | 10 | 19 | 21 | 21 | 26 | 17 |

Key filter media properties

| | | | | | | |
|---|---|---|---|---|---|---|
| Total Basis Weight (gsm) | 17.3 | 27.84 | 29.37 | 29 | 33.8 | 24.5 |
| Textest Air Permeability (196 Pa) | 420 | 320 | 245 | 237 | 236 | 1 Layer: 540 |
| (1/m²/s) | | | | | | 2 Layers 273 |
| Palas (particle filtration efficiency) | 69.13 | 97.93 | 92.61 | 99.5 | 99.9 | 1 layer: 70.33 |
| @3 μm | | | | | | 2 layers: 98.10 |
| Total cellulose based fiber content | 69% | 87% | 99%* | 100% | 78% | 100% |
| | | | *1% of | | | |
| | | | Kymene | | | |

TABLE 2

| | | | |
|---|---|---|---|
| Fibers used | Ex. 2.1 | Ex. 2.2 | Ex. 2.3 |

Top phase

| | |
|---|---|
| Fibrillated Lyocell (60-70 SR) | 25% |
| Pontevedra (35-45° SR) | 75% |
| Top phase basis weight (gsm) | 9 |

Base phase

| | |
|---|---|
| Abaca 410 (35-40° SR) | 30% |
| Teijin TA04PN 3 mm/0.1 dtex | 30% |
| Lyocell 6 mm/ 1.7 dtex | 10% |
| Pontevedra (35-40° SR) | 30% |
| Base phase basis weight (gsm) | 19 |

Key filter media properties

| | | | |
|---|---|---|---|
| Basis Weight (gsm) | 27.1 | 27.04 | 27.5 |
| Textest Air Permeability (196 Pa) | 207 | 307 | 295 |
| (l/m²/s) | | | |
| Palas (particle filtration efficiency) | 99.43 | 98.92 | 99.4 |
| @ 3 μm | | | |
| Total cellulose based fiber content | 79% | 79% | 79% |

The following observations were observed from the experimental data and other testing data.

For Examples 1 and 2, different handsheets having the composition on the tables were prepared. The handsheets are pressed to remove excess water and are dried. For Examples 1.1-1.6 the handsheets were pressed 1×1 kg and dried in a glazing unit.

For Examples 2.1-2.3, the samples were first pressed at either 1×1 kg or 3×3 kg and were dried in a glazing unit. One handsheet (example 2.4) was dried in a drying oven.

### Examples 1.1-1.6

Example 1.1 is a comparative example comprising a high amount of synthetic fibers in the top phase and a base phase of cellulosic fibers. One can see that the air permeability is satisfactory, but the filtration efficiency is rather low and does not meet the desired requirements.

Examples 1.3, 1.4 and 1.6 are examples according to aspects of the invention and are composed of at least 99% of cellulose fiber content. All the air permeability values are above 2001/m²/s and a particle filtration efficiency of at least 90%. For Example 1.6, this result was achieved with 2 layers. The inventors reduced the basis weight of the top phase and the bottom phase. With this, the air permeability was highly increased but the filtration efficiency was reduced. By using a 2-layer construction, a satisfactory level of filtration efficiency was achieved and the air permeability values remained at a desired level.

For examples 1.2 and 1.5 are examples according to the invention wherein synthetic fibers were used. Such fibers can help improve the air permeability. It is believed that synthetic fibers with small dtex values are useful in obtaining bacterial filtration efficiency.

Example 1.3 contains 1% of Kymene (GHP20) which is a wet strength agent and improves the wet strength of the filter media. Though not required, the wet strength agent can be useful for face mask applications where the filter media will be exposed to some moisture.

### Examples 2.1-2.4

These examples illustrate some process parameters, such as wet-pressing and the drying method. In Examples 2.1 and 2.3 the handsheets were pressed at 3×3 kg and in Example 2.2, the handsheet was pressed at 1×1 kg. By comparing Examples 2.1 and 2.2, one can see that the pressing tends to reduce highly the air permeability with minor impact on the filtration efficiency. In Examples 2.1 and 2.2, the handsheets were dried in a glazing unit, whereas the handsheet of Example 2.3 was dried in the oven. Thus, it appears that oven drying opens the web structure of the filter media, and thus the air permeability is better compared to a handsheet dried in a glazing unit. The oven drying method is similar in terms of approach to Through Air Dryer cylinders (TAD) used at industrial scale for drying filter media.

The present invention can be further understood with reference to the following paragraphs:
1. A biodegradable facial mask (18) comprising a cellulose-based filter media (10), wherein the cellulose-based filter media (10) comprises a first phase (14) and a second phase (16), wherein the first phase (14) comprises refined cellulose fibers, and wherein the second phase (16) comprises cellulose fibers along with at least one of cellulose-based man-made fibers or non-cellulose man-made fibers.
2. The biodegradable facial mask (18) according to paragraph 1, wherein the filter media (10) is at least 50% biodegradable, at least 60% biodegradable, at least 75%, at least 95%, or at least 99% biodegradable according to EN 13432.
3. The biodegradable facial mask (18) according to any one of the preceding paragraphs, wherein the filter media (10) is compostable according to EN13432, ASTM D6400 or ASTM D6868 standards.
4. The biodegradable facial mask (18) according to any one of the preceding paragraphs, wherein the filter media (10) comprises a total thickness of 40 to 200 μm.
5. The biodegradable facial mask (18) according to any one of the preceding paragraphs, wherein the first phase (14) comprises at least 25 wt %, at least 50% wt %, at least 60 wt %, at least 75 wt %, at least 80 wt %, or at least 90 wt % of the refined cellulose fibers.
6. The biodegradable facial mask (18) according to any one of the preceding paragraphs, wherein the first phase (14) comprises 100 wt % refined cellulose fibers.
7. The biodegradable facial mask (18) according to any one of the preceding paragraphs, wherein the refined cellulose fibers of the first phase (14) are derived from hardwood pulp, for example, Pontevedra pulp, Celtejo TF CF pulp or Cenibra EC pulp.
8. The biodegradable facial mask (18) according to any one of the preceding paragraphs, wherein the first phase (14) has a thickness 5 μm to 70 μm and the second phase (16) has a thickness 35 μm to 150 μm.
9. The biodegradable facial mask (18) according to any one of the preceding paragraphs, wherein the first phase (14) comprises a basis weight of 4 to 15 gsm and the second phase (16) comprises a basis weight of 10 to 40 gsm.
10. The biodegradable facial mask (18) according to any one of the preceding paragraphs, wherein the cellulose-based man-made fibers are present in the second phase (16) and are selected from the group consisting of Lyocell, fibrillated Lyocell, and viscose fibers, such as Rayon.
11. The biodegradable facial mask (18) according to any one of the preceding paragraphs, wherein the cellulose-based man-made fibers are present and comprise a fineness of 0.5 to 5 dtex and a length of 1 to 20 mm, preferably 3 to 8 mm.
12. The biodegradable facial mask (18) according to any one of the preceding paragraphs, wherein the non-cellulose man-made fibers are present in the second phase (16) and are selected from the group consisting of polyesters, co-polyesters, bicomponent polyester/polyolefin, modified polyesters, polyolefin, polyaramids, polyamides or biopolymers such as polylactic acids, polybutylene succinates, polybutylene succinate co-adipates, polycaprolactones, polybutyrate adipate terephthalates, and combinations thereof
13. The biodegradable facial mask (18) according to any one of the preceding paragraphs, wherein the non-cellulose man-made fibers have a fineness of 0.02 to 1 dtex and a length of 0.5-15 mm, preferably 1-10 mm.
14. The biodegradable facial mask (18) according to any one of the preceding paragraphs, wherein the cellulose fibers of the second phase (16) comprise refined cellulose fibers.
15. The biodegradable facial mask (18) according to any one of the preceding paragraphs,
wherein the refined cellulose fibers of the second phase (16) comprise softwood fibers or annual plant fibers, such as Abaca fibers.
16. The biodegradable facial mask (18) according to any one of the preceding paragraphs, wherein the filter media (10) comprises at least 50 wt % refined cellulose fibers.
17. The biodegradable facial mask (18) according to paragraph 16, wherein the filter media (10) comprises at least 60 wt %, preferably at least 65 wt % refined cellulose fibers.
18. The biodegradable facial mask (18) according to any one of the preceding paragraphs,
wherein the second phase (16) comprises the following composition:
   from 30 to 90 wt % of refined cellulose fibers;
   from 0 to 40 wt % unrefined cellulose-based man-made fibers;
   from 0 to 25 wt % of cellulose-based man-made fibers; and
   from 0 to 50 wt % of non-cellulose man-made fibers.
19. The biodegradable facial mask (18) according to any one of the preceding paragraphs,
wherein the second phase (16) comprises the following composition:
   from 15 to 45 wt % of first refined cellulose fibers refined to a level from 20° SR to 55° SR;
   from 15 to 45 wt % of second refined cellulose fibers different from the first refined cellulose fiber refined to a level from 20° SR to 55° SR;
   from 0 to 40 wt % unrefined cellulose-based man-made fibers;
   from 0 to 25 wt % of cellulose-based man-made fibers refined to a level of from 50° SR to 85° SR;
   from 0 to 20 wt % cellulose fibers refined to a level of from 45° SR to 85° SR; and
   from 0 to 50 wt % of non-cellulose man-made fibers.
20. The biodegradable facial mask (18) according to any one of the preceding paragraphs, wherein the first phase (14) is thinner than the second phase (16) in the filter media (10).
21. The biodegradable facial mask (18) according to any one of the preceding paragraphs, wherein the filter media (10) comprises a single layer of the filter media, and wherein the filter media (10) has a total basis weight of between 15 to 65 gsm, preferably to 35 gsm.
22. The biodegradable facial mask (18) according to any one of the preceding paragraphs, wherein the filter media (10) comprises at least two layers (12a, 12b) of filter media, and wherein the at least two layers of filter media have a total basis weight of 30 to 130 gsm, preferably 40 to 70 gsm.
23. The biodegradable facial mask (18) according to any one of the preceding paragraphs, wherein the filter media (10) further comprises a wet strength agent.
24. The biodegradable facial mask (18) according to any one of the preceding paragraphs, wherein the filter media (10) is formed via a wet-laid process.
25. The biodegradable facial mask (18) according to any one of the preceding paragraphs, wherein the filter media (10) has a particle filtration efficiency (PFE) of at least 70% at 3 μm, preferably at least 95%, measured using 3 μm Di-Ethyl-Hexyl-Sebacat (DEHS) particles.
26. The biodegradable facial mask (18) according to any one of the preceding paragraphs, wherein the filter media (10) has a bacterial filtration efficiency (BFE) greater than 50%, preferably at least 95% according to the EN 14683: 2019, Annex B standard or the ASTM F2101-19 standard.
27. The biodegradable facial mask (18) according to any one of the preceding paragraphs, wherein the filter media (10) has an air permeability of filtration layer of from 200 to 800 L/m²/s (Textest Air Permeability at 196 Pa).
28. The biodegradable facial mask (18) according to any one of the preceding paragraphs, wherein the filter media (10) has a micro-bacterial cleanliness of ≤30 cfu/g according to the EN 14683 standard or ISO 11737-1 standard.
29. The biodegradable facial mask (18) according to any one of the preceding paragraphs, wherein the filter media (10) has a differential pressure less than 60 Pa/cm², preferably less than 40 Pa/cm² according to the EN 14683:2019, Annex C standard or the ASTM F2100-19 standard.
30. The biodegradable facial mask (18) according to any one of the preceding paragraphs, wherein the cellulose fibers of the second phase (16) comprise refined cellulose fibers, and wherein the cellulose fibers of the first phase (14) or the second phase (16) are refined to a level from 20° SR to 85° SR.
31. The biodegradable facial mask (18) according to claim 29, wherein the refined cellulose fibers of the first phase (14) are refined to a level from 45° SR to 60° SR.
32. The biodegradable facial mask (18) according to any one of the preceding paragraphs, wherein the filter media (10) is interchangeable within a body of the facial mask.
33. The biodegradable facial mask (18) according to any one of the preceding paragraphs, wherein the facial mask (18) is at least 60% biodegradable, preferably at least 95% biodegradable, and more preferably at least 99% biodegradable.
34. The biodegradable facial mask (18) according to any one of the preceding paragraphs, wherein the filter media (10) is sandwiched between a first layer (20) intended to be in contact with the face of a user when worn and a second layer (22) intended to be in contact with the environment when worn by the user.
35. The biodegradable facial mask (18) according to any one of the preceding paragraphs, wherein the first layer (20) comprises a wet laid fibrous layer.
36. The biodegradable facial mask (18) according to any one of the preceding paragraphs, wherein either or both of first and second layers comprise a spunbond layer, wherein the spunbond layer comprises a member selected from the group consisting of polypropylene, polyethylene, one or more biopolymers, and combinations thereof.
37. The biodegradable facial mask (18) according to paragraph 36, wherein the biopolymers are selected from polylactic acids, polybutylene succinates, polybutylene succinate co-adipates, polycaprolactones, or polybutyrate adipate terephthalates.
38. The biodegradable facial mask (18) according to any one of the preceding paragraphs, wherein the mask is a surgical mask or a civil mask.
39. A cellulose-based filter media (10) comprising a first phase (14) and a second phase (16), wherein the first phase (14) comprises refined cellulose fibers, and wherein the second phase (16) comprises cellulose fibers along with at least one of cellulose-based man-made fibers or non-cellulose man-made fibers.
40. The filter media (10) according to paragraph 39, wherein the filter media (10) is at least 50% biodegradable, at least 60% biodegradable, at least 75%, at least 95%, or at least 99% biodegradable according to EN 13432.
41. The filter media (10) according to any one of paragraphs 39 to 40, wherein the filter media (10) is compostable according to EN13432, ASTM D6400 or ASTM D6868 standards.
42. The filter media (10) according to any one of paragraphs 39 to 41, wherein the filter media (10) comprises a total thickness of 40 to 200 μm.
43. The filter media (10) according to any one of paragraphs 39 to 42, wherein the first phase (14) comprises at least 25 wt %, at least 50% wt %, at least 60 wt %, at least 75 wt %, at least 80 wt %, or at least 90 wt % of the refined cellulose fibers.
44. The filter media (10) according to any one of paragraphs 39 to 43, wherein the first phase (14) comprises 100 wt % refined cellulose fibers.
45. The filter media (10) according to any one of paragraphs 39 to 44, wherein the refined cellulose fibers of the first phase (14) are derived from hardwood pulp, for example, Pontevedra pulp, Celtejo TF CF pulp or Cenibra EC pulp.
46. The filter media (10) according to any one of paragraphs 39 to 45, wherein the first phase (14) has a thickness 5 μm to 70 μm and the second phase (16) has a thickness 35 μm to 150 μm.
47. The filter media (10) according to any one of paragraphs 39 to 46, wherein the first phase (14) comprises a basis weight of 4 to 15 gsm and the second phase (16) comprises a basis weight of 10 to 40 gsm.
48. The filter media (10) according to any one of paragraphs 39 to 47, wherein the cellulose-based man-made fibers are present in the second phase (16) and are selected from the group consisting of Lyocell, fibrillated Lyocell, and viscose fibers, such as Rayon.
49. The filter media (10) according to any one of paragraphs 39 to 48, wherein the cellulose-based man-made fibers are present and comprise a fineness of 0.5 to 5 dtex and a length of 1 to 20 mm, preferably 3 to 8 mm.
50. The filter media (10) according to any one of paragraphs 39 to 49, wherein the non-cellulose man-made fibers are present in the second phase (16) and are selected from the group consisting of polyesters, co-polyesters, bicomponent polyester/polyolefin, modified polyesters, polyolefin, polyaramids, polyamides or biopolymers such as polylactic acids, polybutylene succinates, polybutylene succinate co-adipates, polycaprolactones, polybutyrate adipate terephthalates, and combinations thereof
51. The filter media (10) according to any one of paragraphs 39 to 50, wherein the non-cellulose man-made fibers have a fineness of 0.02 to 1 dtex and a length of 0.5-15 mm, preferably 1-10 mm.
52. The filter media (10) according to any one of paragraphs 39 to 51, wherein the cellulose fibers of the second phase (16) comprise refined cellulose fibers.
53. The filter media (10) according to any one of paragraphs 39 to 52, wherein the refined cellulose fibers of the second phase (16) comprise softwood fibers or annual plant fibers, such as Abaca fibers.
54. The filter media (10) according to any one of paragraphs 39 to 53, wherein the filter media (10) comprises at least 50 wt % refined cellulose fibers.
55. The filter media (10) according to any one of paragraphs 39 to 54, wherein the filter media (10) comprises at least 60 wt %, preferably at least 65 wt % refined cellulose fibers.
56. The filter media (10) according to any one of paragraphs 39 to 55, wherein the second phase (16) comprises the following composition:
   from 30 to 90 wt % of refined cellulose fibers;
   from 0 to 40 wt % unrefined cellulose-based man-made fibers;
   from 0 to 25 wt % of cellulose-based man-made fibers; and
   from 0 to 50 wt % of non-cellulose man-made fibers.
57. The filter media (10) according to any one of paragraphs 39 to 56, wherein the second phase (16) comprises the following composition:
   from 15 to 45 wt % of first refined cellulose fibers refined to a level from 20° SR to 55° SR;
   from 15 to 45 wt % of second refined cellulose fibers different from the first refined cellulose fiber refined to a level from 20° SR to 55° SR;
   from 0 to 40 wt % unrefined cellulose-based man-made fibers;
   from 0 to 25 wt % of cellulose-based man-made fibers refined to a level of from 50° SR to 85° SR;
   from 0 to 20 wt % cellulose fibers refined to a level of from 45° SR to 85° SR; and
   from 0 to 50 wt % of non-cellulose man-made fibers.
58. The filter media (10) according to any one of paragraphs 39 to 57, wherein the first phase (14) is thinner than the second phase (16) in the filter media (10).
59. The filter media (10) according to any one of paragraphs 39 to 58, wherein the filter media (10) comprises a single layer of the filter media, and wherein the filter media (10) has a total basis weight of between 15 to 65 gsm, preferably 25 to 35 gsm.
60. The filter media (10) according to any one of paragraphs 39 to 59, wherein the filter media (10) comprises at least two layers (12a, 12b) of filter media, and wherein the at least two layers of filter media have a total basis weight of 30 to 130 gsm, preferably 40 to 70 gsm.
61. The filter media (10) according to any one of paragraphs 39 to 60, wherein the filter media (10) further comprises a wet strength agent.
62. The filter media (10) according to any one of paragraphs 39 to 61, wherein the filter media (10) is formed via a wet-laid process.
63. The filter media (10) according to any one of paragraphs 39 to 62, wherein the filter media (10) has a particle filtration efficiency (PFE) of at least 70% at 3 μm, preferably at least 95%, measured using 3 μm Di-Ethyl-Hexyl-Sebacat (DEHS) particles.
64. The filter media (10) according to any one of paragraphs 39 to 63, wherein the filter media (10) has a bacterial filtration efficiency (BFE) greater than 50%, preferably at least 95% according to the EN 14683: 2019, Annex B standard or the ASTM F2101-19 standard.
65. The filter media (10) according to any one of paragraphs 39 to 64, wherein the filter media (10) has an air permeability of filtration layer of from 200 to 800 L/m²/s (Textest Air Permeability at 196 Pa).
66. The filter media (10) according to any one of paragraphs 39 to 65, wherein the filter media (10) has a micro-bacterial cleanliness of ≤30 cfu/g according to the EN 14683 standard or ISO 11737-1 standard.
67. The filter media (10) according to any one of paragraphs 39 to 66, wherein the filter media (10) has a differential pressure less than 60 Pa/cm², preferably less than 40 Pa/cm² according to the EN 14683:2019, Annex C standard or the ASTM F2100-19 standard.
68. The filter media (10) according to any one of paragraphs 39 to 67, wherein the cellulose fibers of the second phase (16) comprise refined cellulose fibers, and wherein the cellulose fibers of the first phase (14) or the second phase (16) are refined to a level from 20° SR to 85° SR.
69. The filter media (10) according to paragraph 68, wherein the refined cellulose fibers of the first phase (14) are refined to a level from 45° SR to 60° SR.
70. The filter media (10) according to any one of paragraphs 39 to 69, wherein the filter media (10) is interchangeable within a body of a facial mask (18).
71. A process for manufacturing a cellulose-based filter media (10) according to any one of paragraphs 39 to 70 comprising:
   wet laying and draining at least two furnishes of cellulose fibers onto a screen assembly to form a web, wherein the at least two furnishes provide a first phase (14) and a second phase (16) in the web, wherein the first phase (14) comprises refined cellulose fibers, and wherein the second phase (16) comprises cellulose fibers along with at least one of cellulose-based man-made fibers or non-cellulose man-made fibers; and
   drying the web to form the cellulose-based filter media (10).
72. The process according to paragraph 71, wherein the formed cellulose-based filter media (10) is at least 50% biodegradable, at least 60% biodegradable, at least 75%, at least 95%, or at least 99% biodegradable according to EN 13432.
73. The process according to paragraph 67, wherein at least 50 wt %, at least 60 wt %, at least 75 wt %, at least 80 wt %, or at least 90 wt % of the cellulose fibers of the filter media (10) comprises refined cellulose fibers.
74. The process according to any one of paragraphs 71 to 73, wherein the cellulose fibers of the second phase (16) comprise refined cellulose fibers.
75. The process according to paragraph 74, wherein the refined cellulose fibers of the first phase (14) or the second phase (16) are refined to a level from 20° SR to 85° SR, for example 45° SR to 60° SR.
76. The facial mask, filter media, or process according to any one of paragraphs 1 to 75, wherein the refined cellulose fibers comprises at least 30%, preferably at least 34% in length of fines.
77. The facial mask, filter media, or process according to any one of paragraphs 1 to 76, wherein the refined cellulose fibers comprise at least 0.35% in length of macrofibrills.

Reference throughout this specification to “one embodiment” or “an embodiment” means that a particular feature, structure, or characteristic described in connection with the embodiment is included in at least one embodiment of the present invention. Thus, appearances of the phrases “in one embodiment” or “in an embodiment” in various places throughout this specification are not necessarily all referring to the same embodiment.

Furthermore, the described features, structures, or characteristics may be combined in any suitable manner in one or more embodiments. In the following description, numerous specific details are provided, such as examples of lengths, widths, shapes, etc., to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

1-75. (canceled)

76. A biodegradable facial mask comprising a cellulose-based filter media, wherein the cellulose-based filter media comprises a first phase and a second phase, wherein the first phase comprises refined cellulose fibers, and wherein the second phase comprises cellulose fibers along with at least one of cellulose-based man-made fibers or non-cellulose man-made fibers.

77. The biodegradable facial mask according to claim 76, wherein the filter media is at least 50% biodegradable, according to EN 13432 and is compostable according to EN13432, ASTM D6400 or ASTM D6868 standards.

78. The biodegradable facial mask according to claim 76, wherein the first phase comprises at least 25 wt % of the refined cellulose fibers.

79. The biodegradable facial mask according to claim 76, wherein the refined cellulose fibers of the first phase are derived from hardwood pulp, and wherein the refined cellulose fibers of the second phase comprise softwood fibers or annual plant fibers.

80. The biodegradable facial mask according to claim 76, wherein the first phase has a thickness 5 μm to 70 μm and the second phase has a thickness 35 μm to 150 μm, and wherein the first phase comprises a basis weight of 4 to 15 gsm and the second phase comprises a basis weight of 10 to 40 gsm.

81. The biodegradable facial mask according to claim 76, wherein the cellulose-based man-made fibers are present in the second phase and are selected from the group consisting of Lyocell, fibrillated Lyocell, and viscose fibers, and wherein the cellulose-based man-made fibers are present and comprise a fineness of 0.5 to 5 dtex and a length of 1 to 20 mm.

82. The biodegradable facial mask according to claim 76, wherein the non-cellulose man-made fibers are present in the second phase and are selected from the group consisting of polyesters, co-polyesters, bicomponent polyester/polyolefin, modified polyesters, polyolefin, polyaramids, polyamides, biopolymers, polylactic acids, polybutylene succinates, polybutylene succinate co-adipates, polycaprolactones, polybutyrate adipate terephthalates, and combinations thereof, and wherein the non-cellulose man-made fibers have a fineness of 0.02 to 1 dtex and a length of 0.5-15 mm.

83. The biodegradable facial mask according to claim 76, wherein the cellulose fibers of the second phase comprise refined cellulose fibers.

84. The biodegradable facial mask according to claim 76, wherein the refined cellulose fibers of the second phase comprise softwood fibers or annual plant fibers.

85. The biodegradable facial mask according to claim 76, wherein the filter media comprises at least 50 wt % refined cellulose fibers.

86. The biodegradable facial mask according to claim 76, wherein the second phase comprises the following composition:
from 30 to 90 wt % of refined cellulose fibers;
from 0 to 40 wt % unrefined cellulose-based man-made fibers;
from 0 to 25 wt % of cellulose-based man-made fibers; and
from 0 to 50 wt % of non-cellulose man-made fibers.

87. The biodegradable facial mask according to claim 76, wherein the second phase comprises the following composition:
from 15 to 45 wt % of first refined cellulose fibers refined to a level from 20° SR to 55° SR;
from 15 to 45 wt % of second refined cellulose fibers different from the first refined cellulose fiber refined to a level from 20° SR to 55° SR;
from 0 to 40 wt % unrefined cellulose-based man-made fibers;
from 0 to 25 wt % of cellulose-based man-made fibers refined to a level of from 50° SR to 85° SR;
from 0 to 20 wt % cellulose fibers refined to a level of from 45° SR to 85° SR; and
from 0 to 50 wt % of non-cellulose man-made fibers.

88. The biodegradable facial mask according to claim 76, wherein the first phase is thinner than the second phase in the filter media.

89. The biodegradable facial mask according to claim 76, wherein the filter media is formed via a wet-laid process.

90. The biodegradable facial mask according to claim 76, wherein the filter media has:
a particle filtration efficiency (PFE) of at least 70% at 3 μm, measured using 3 μm Di-Ethyl-Hexyl-Sebacat (DEHS) particles;
a bacterial filtration efficiency (BFE) greater than 50%, according to the EN 14683: 2019, Annex B standard or the ASTM F2101-19 standard;
an air permeability of filtration layer of from 200 to 800 L/m²/s (Textest Air Permeability at 196 Pa);
a micro-bacterial cleanliness of ≤30 cfu/g according to the EN 14683 standard or ISO 11737-1 standard; and/or
a differential pressure less than 60 Pa/cm², according to the EN 14683:2019, Annex C standard or the ASTM F2100-19 standard.

91. The biodegradable facial mask according to claim 76, wherein the cellulose fibers of the second phase comprise refined cellulose fibers, and wherein the cellulose fibers of the first phase or the second phase are refined to a level from 20° SR to 85° SR.

92. The biodegradable facial mask according to claim 76, wherein the filter media is sandwiched between a first layer intended to be in contact with the face of a user when worn and a second layer intended to be in contact with the environment when worn by the user.

93. The biodegradable facial mask according to claim 92, wherein the first layer comprises a wet laid fibrous layer.

94. The biodegradable facial mask according to claim 92, wherein either or both of first and second layers comprise a spunbond layer, and wherein the spunbond layer comprises a member selected from the group consisting of polypropylene, polyethylene, one or more biopolymers, and combinations thereof.

95. The biodegradable facial mask according to claim 94, wherein the one or more biopolymers are presents and are selected from polylactic acids, polybutylene succinates, polybutylene succinate co-adipates, polycaprolactones, or polybutyrate adipate terephthalates.

96. The biodegradable facial mask according to claim 76, wherein the mask is a surgical mask or a civil mask.
